(19) United States
(12) Patent Application Publication
(10) Pub. No.: US 2009/0276320 A1
(43) Pub. Date: Nov. 5, 2009

(54) BEZEL FOR VENDING OR GAMING MACHINE

(75) Inventors: Glenn Butler, Holliston, MA (US); Craig Lewis, Berwyn, PA (US); Dmytro Baydin, Etobicoke (CA)

Correspondence Address: DOCKET CLERK, P.O. DRAWER 800889, DALLAS, TX, 75380, US

(73) Assignee: Crane Co., Stamford, CT (US)

(21) Appl. No.: 12/412,271

(22) Filed: Mar. 26, 2009

Related U.S. Application Data
(60) Provisional application No. 61/070,912, filed on Mar. 26, 2008.

(51) Int. Cl. G06Q 20/00; G06Q 40/00; G06Q 50/00; G06F 3/041

(52) U.S. Cl. 705/17; 705/41; 345/173

(57) ABSTRACT

A bezel for use in a merchandising system is provided. The bezel includes an information display and a graphic display including one or more visual indicators. The bezel also includes a card reader configured to process payments from a cashless payment card. The bezel further includes a bill recycler access slot providing access to a bill recycler. In the bezel, illumination of the graphic display is controlled in response to information received from the bill recycler.

### CROSS REFERENCE TO RELATED APPLICATIONS

This utility application claims priority to U.S. Provisional Patent Application No. 61/070,912 entitled “BEZEL FOR VENDING OR GAMING MACHINE” and filed Mar. 26, 2008. The content of the above-identified application is incorporated herein by reference.

### TECHNICAL FIELD

The present invention is directed, in general, to vending mechanisms and, more specifically, to a bezel for monetary transactions on a vending or gaming machine.

### BACKGROUND

Vending machines are often employed to deliver food, such as sandwiches, snacks or other items, in environments having limited access to alternative food service establishments or not warranting the expense of one or more food service attendants, either continually or during “off-peak” periods. Such environments include sites too remote from off-site food service establishments or work environments in which different shifts (e.g., a night shift) coincide with periods of limited availability of open food service establishments.

Gaming machines are frequently located in public places to provide amusement and opportunities to win or earn prizes. Some gaming machines offer players a chance to test their skills against a computerized opponent or against each other. Some gaming machines allow players to earn points, tickets, or tokens that may be redeemed for various prizes and merchandise. Collectively, gaming machines and vending machines may be referred to as merchandising systems.

A front panel of a merchandising system may include one or more product presentation or game playing regions, a region for delivery of purchased products or winnings to a user of the machine, a user interface region for display of machine status and for the user to select a product or game, a region for depositing currency/coins, and/or a region for receiving currency/coins as change. One or more of these functions may be combined into a single region of the machine front panel.

### SUMMARY

A bezel for use in a merchandising system is provided. The bezel includes an information display. The bezel also includes a graphic display including one or more visual indicators. The bezel further includes a card reader configured to process payments from a cashless payment card. The bezel still further includes a bill recycler access slot providing access to a bill recycler. In the bezel, illumination of the graphic display is controlled in response to information received from the bill recycler.

A merchandising system is provided. The merchandising system includes a controller, a bill recycler, and a bezel. The bezel includes an information display. The bezel also includes a graphic display including one or more visual indicators. The bezel further includes a card reader configured to process payments from a cashless payment card. The bezel still further includes a bill recycler access slot providing access to the bill recycler. In the bezel, illumination of the graphic display is controlled in response to information received from the bill recycler.

A method for operating a bezel in a merchandising system is provided. The method includes displaying a message in an information display. The method also includes receiving information related to a status of the bill recycler. The method further includes providing access to a currency bill through a bill recycler access slot operatively coupled to a bill recycler. The method still further includes illuminating a pattern of one or more visual indicators in a graphic display in response to the status of the bill recycler.

The foregoing has outlined rather broadly the features and technical advantages of the structures and methods described herein so that those skilled in the art may better understand the detailed description that follows. Additional features and advantages will be described hereinafter that form the subject of the claims. Those skilled in the art will appreciate that they may readily use the conception and the specific embodiment disclosed as a basis for modifying or designing other structures for carrying out the same purposes. Those skilled in the art will also realize that such equivalent constructions do not depart from the spirit and scope of the present disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIGS. 1-3 show front elevation, side cutaway and perspective views, respectively, of a combination bezel according to one embodiment of the present disclosure;

FIG. 4 shows a view of a bezel mounted to a section of a front face of a vending or gaming machine, according to one embodiment of the present disclosure; and

FIG. 5 illustrates a vending machine incorporating a combination bezel according to one embodiment of the present disclosure.

### DETAILED DESCRIPTION

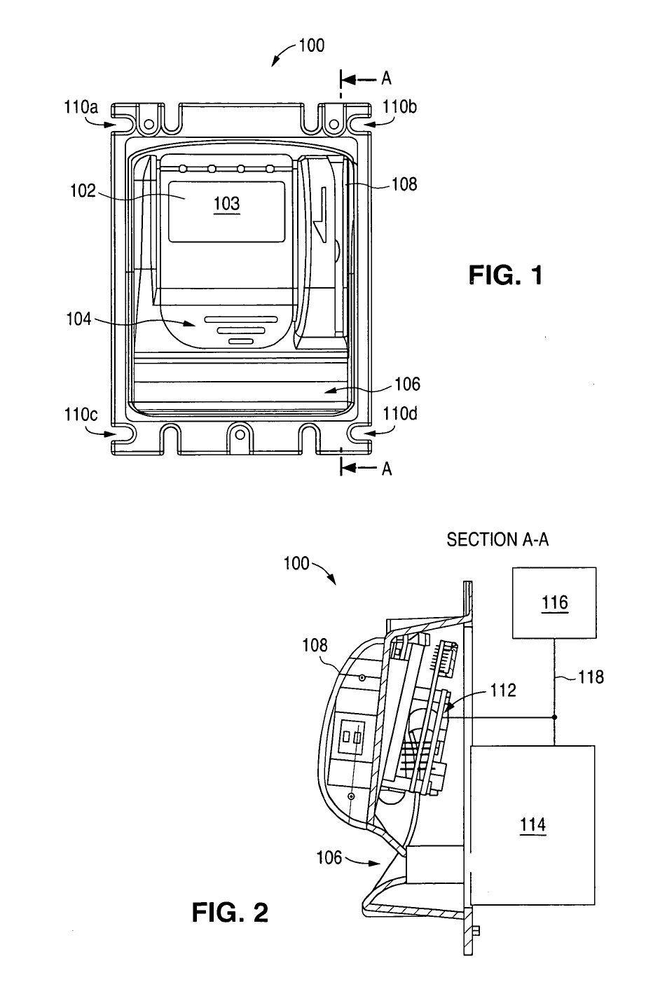

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device.

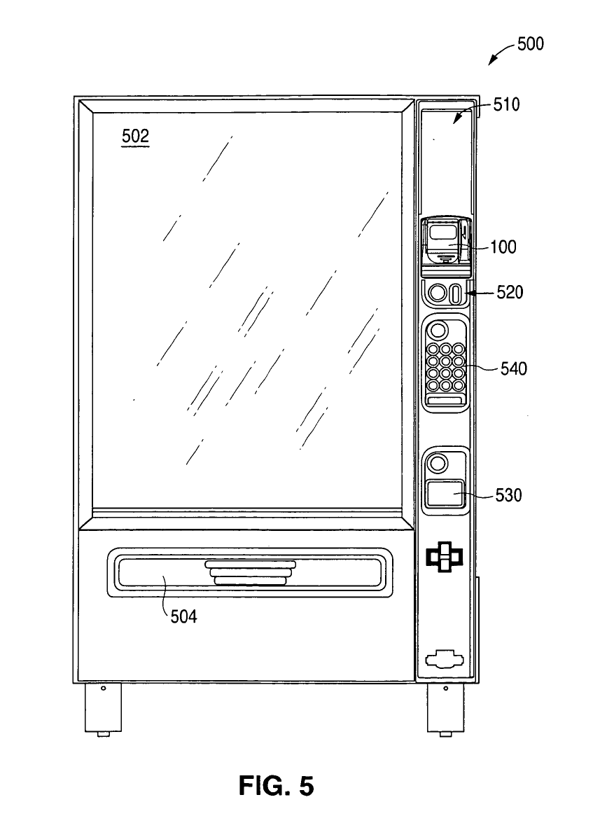

FIG. 5 illustrates a merchandising system 500 incorporating a combination bezel 100 according to one embodiment of the present disclosure. It is understood that the illustration of merchandising system 500 is exemplary. Other vending, merchandising, or gaming systems incorporating the combination bezel 100 are also possible without departing from the scope of this disclosure.

Merchandising system 500 has a product display and storage area 502 and a delivery door 504. Additionally, merchandising system 500 includes a user interface area 510. Depiction of the user interface area 510 along one side of the face of the vending machine is exemplary only and should not be construed as limited to this configuration. For example, the user interface area 510 may be located along the left side of the face of the merchandising system 500. Additionally or alternatively, the user interface area 510 may be located in any other user-accessible portion of the merchandising system 500. While shown adjacent to each other, in other embodiments, certain subsections of the user interface 510 may be located in different portions of the merchandising system 500.

The user interface 510 includes a coin insert 520. The coin insert 520 is adapted to receive currency in the form of coins. The user interface 510 includes a change return slot (or aperture) 530. The change return slot 530 is configured to return currency to a consumer in the form of coins. In some embodiments, the change return slot 530 includes a user-accessible bin, or tray for holding the returned coins.

The user interface 510 includes a combination bezel 100. The combination bezel 100 replaces a card reader and bill validator that are typically disposed in separate locations on many conventional vending machines. In the embodiment shown in FIG. 5, the combination bezel 100 is located in the top third of user interface 510. However, the combination bezel 100 may be located in different portions of the merchandising system 500. For example, in certain embodiments, combination bezel 100 may be located below change return slot 530. In other embodiments, combination bezel 100 may be below coin insert 520 but above a keypad/selection device 540.

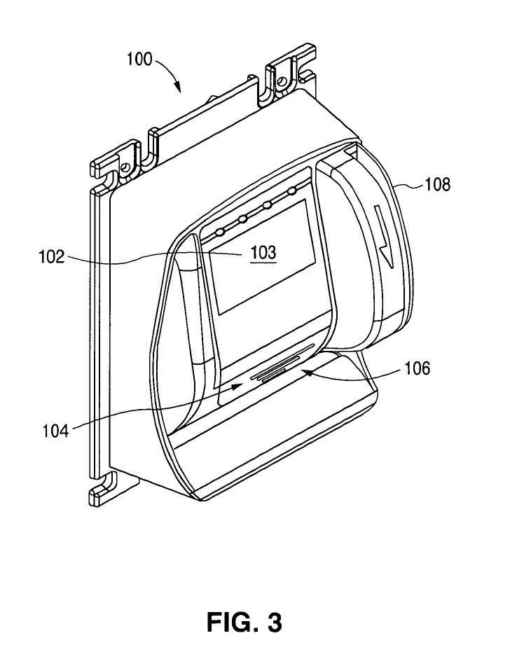

FIGS. 1 and 2 show front elevation and side cutaway views, respectively, of a combination bezel 100 according to one embodiment of the present disclosure. The bezel 100 combines the user interface for both a card reader 108 and a bill recycler 114 into one integrated housing. The bill recycler 114 is an apparatus capable of accepting paper currency bills as payment, processing, and providing paper currency bills as change or unused credit. Bill recyclers are described in greater detail in U.S. Provisional Patent Application No. 61/196,017 entitled “VENDING MACHINE INTEROPERABLE RECYCLER” and filed Oct. 14, 2008, which is incorporated herein by reference.

The combination bezel 100 includes four mounting slots 110a-d that may be used to attach the bezel 100 to the merchandising system 500. The combination bezel 100 also includes an information display 102 for displaying information that may include machine status and customer interaction messages. In certain embodiments, the information display 102 is a backlit liquid crystal display (LCD). In other embodiments, the information display 102 may include pixelated light emitting diodes (LED), plasma, or any other technology capable of displaying information. The information display 102 may also include a touch sensitive input device 103, to enable a user of the machine to make selections from choices shown on the display, or otherwise interact with the merchandising system 500.

A graphic display 104 located below the information display 102 includes a number of visual indicators, such as light emitting diodes (LEDs). In certain embodiments, the LEDs comprise horizontal bars arranged in a vertical column, where each bar is narrower than the bar above it, thus creating a visual arrowhead pointing down towards a bill recycler access slot 106. It will be understood that, in other embodiments, the graphic display 104 may include other display technologies (e.g., LCD, neon, incandescent), and include arrangements other than horizontal bars.

The graphic display 104 is controlled based upon instruction signals received by the combination bezel 100 from a controller (not shown) located in the bill recycler 114. Based on the instruction signals from the controller, the graphic display 104 displays patterns of animation and illumination in one or more colors to direct a customer's attention to the bill recycler access slot 106 and provide status information about the bill recycler 114. For example, in order to direct the customer's attention to the bill recycler access slot 106, the graphic display 104 may display a pattern in which the horizontal bars illuminate repeatedly in a downward sequence with a blue light, in a manner similar to lights on an airport runway. When the bill recycler 114 is returning (via access slot 106) one or more currency bills as change to the customer, the horizontal bars may display a pattern in which they illuminate with a red color and a reverse (upward) sequence. Another pattern of light sequences or colors may indicate that the bill recycler 114 is full or empty. Other patterns of lighting sequences and colors, both static and animated, are possible to convey additional messages about the bill recycler 114. Operation of the bill recycler 114 is discussed in greater detail below.

A user of the merchandising system 500 may insert bills into the access slot 106 to receive credit for use in purchasing products or services from the merchandising system 500. The access slot 106 provides access to the bill recycler 114, which is mounted the within merchandising system 500. In certain embodiments, the bill recycler access slot 106 is disposed in a recessed area below an overhang formed by the protrusions of the displays 102 and 104. The overhang may serve as a type of shelter, protecting the access slot 106 from weather and wind.

The bill recycler 114 receives and validates bills inserted by the user, providing credit for validated bills and storing the validated bills in the recycler. The bill recycler 114 is configured to store bill denominations separately, such that a first denomination is stored separate from a second denomination (e.g., a five dollar bill ($5.00) is stored separate from a one dollar bill ($1.00)). Bills that are not successfully validated are returned to the user via the slot 106.

Before or after a purchase is made or a game is played, the bill recycler 114 may discharge bills to the user as unused credit or remaining credit after a purchase. Such bills are discharged through the access slot 106. The bill recycler 114 and the bill recycler access slot 106 in the combination bezel 100 provide value and convenience to the customer. Rather than dispense credit in the form of a large quantity of coins, the bill recycler 114 can provide the credit in the form of a smaller number of lightweight bills. For example, if a customer inserts a twenty dollar bill ($20.00) into the bill recycler 114, and purchases an item that costs three dollars ($3.00), the bill recycler 114 may return a ten dollar bill ($10.00), a five dollar bill ($5.00), and two (2) one dollar bills ($1.00) as change. Alternatively, the bill recycler 114 may return two (2) five dollar bills ($5.00) and seven (7) one dollar bills ($1.00), or any other combination that adds up to seventeen dollars ($17.00). This is more desirable for the customer than receiving seventeen (17) one dollar coins or sixty-eight (68) quarters in change.

The bezel 100 also includes a card reader 108 for cashless transactions. The card reader 108 is configured to read data from a payment card such that a vending or game transaction may be charged to an account, such as a credit card account, corresponding to the card. In certain embodiments, the card reader 108 includes a vertical or horizontal slot housing a magnetic sensor to read a magnetic stripe on a card when the card is swiped through the slot. In some embodiments, the card reader 108 also includes a radio frequency (RF) reader to receive data from, and write data to, a smart card (i.e., a card with a chip), an RF-enabled card, or any other contactless card. In other embodiments, the card reader 108 may exchange data with a smart card through induction or by matching contacts in both the card reader 108 and the smart card. Other embodiments of card reader 108 are contemplated. For example, the card reader 108 may include a recess into which a card is inserted and then removed.

In FIG. 2, it can be seen that the combination bezel 100 includes a control card 112. The control card 112 is communicatively coupled by a communication bus 118 (such as a Multi-Drop Bus, or “MDB”) to a vending/gaming machine controller 116 (or other merchandising system controller), the bill recycler 114, and/or other subsystem of merchandising system 500. In certain embodiments, the control card 112 may also be communicatively coupled to the information display 102, the graphic display 104, and/or the card reader 108.

In certain embodiments, the control card 112 may be capable of transmitting, receiving, and/or processing signals via wireless or wire-line communication links. It is understood that illustration of the control card 112 in the position depicted in FIG. 2 is exemplary, and that the control card 112 may be disposed in any suitable location within the combination bezel 100 or other locations in the merchandising system 500.

In certain embodiments, the control card 112 receives a message from the merchandising system controller 116. Based on the message, the control card 112 may cause information to be displayed on the information display 102 or a pattern to be displayed on the graphic display 104. The control card 112 may receive information from the bill recycler 114 and, based on the information, may cause a pattern to be displayed on the graphic display 104. In certain embodiments, the control card 112 may receive card information from, and send information to, the card reader 108. The information from the card reader 108 may include payment information from magnetic stripe, smart cards, or other cashless payment cards. Information from the card reader 108 may be sent to the merchandising system controller 116 via the control card 112.

FIG. 3 illustrates a perspective view of the combination bezel 100 according to one embodiment of the present disclosure. In this view, the positions of the displays 102 and 104, the bill recycler access slot 106, and the card reader 108 on the bezel 100 can be readily seen. The bezel 100 is configured and structured to incorporate all of these elements into one housing module. Integrating these elements into a single subsystem provides several advantages. Having only one component reduces manufacturing costs, enhances portability, and makes installation and repair easier and more streamlined. By integrating several elements into one housing, the combination bezel 100 saves valuable space on the face of the vending or gaming machine. It also makes it easier to comply with federal regulations. For example, locating the combination bezel 100 at a lower position on the face of the vending machine places all of the bezel components in compliance with height requirements found in the Americans with Disabilities Act (ADA).

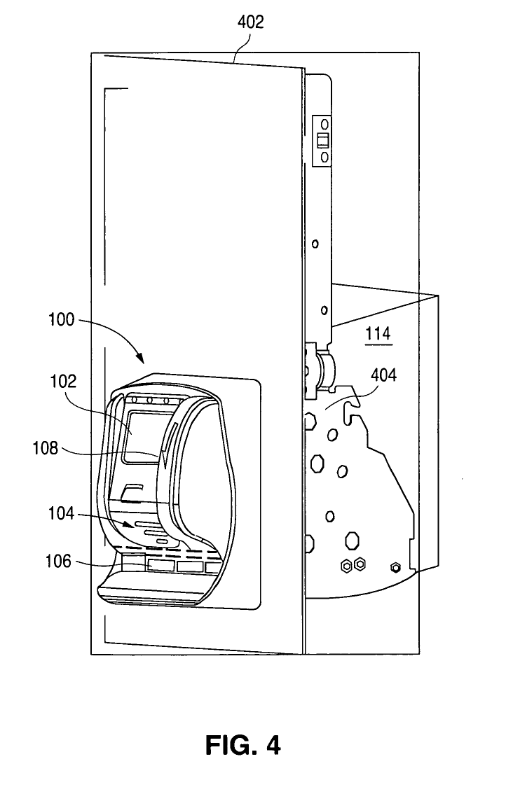

FIG. 4 shows a view of the bezel 100 mounted to a section 402 of a front face of a vending or gaming machine, such as the merchandising system 500, according to one embodiment of the present disclosure. The mounting slots 110a-d may be used to attach the bezel 100 to the section 402. The combination bezel 100 may then be covered with a fascia or overlay. Attached to a back side of the section 402 is a bill recycler frame assembly 404, to which the bill recycler 114 is mounted. An inlet/outlet slot of the bill recycler 114 is aligned with the access slot 106 of the bezel 100 to enable bills to be inserted into and removed from the bill recycler 114 via the access slot 106 on the combination bezel 100.

Although the present disclosure and its advantages have been described in the foregoing detailed description and illustrated in the accompanying drawings, it will be understood by those skilled in the art that this is not limited to the embodiment(s) disclosed but is capable of numerous rearrangements, substitutions and modifications without departing from the spirit and scope of the invention as defined by the appended claims.

What is claimed is:

1. For use in a merchandising system, a bezel comprising:
an information display;
a graphic display comprising one or more visual indicators;
a card reader configured to read information from a cashless payment card; and
a bill recycler access slot providing access to a bill recycler;
wherein illumination of the graphic display is controlled in response to information received from the bill recycler.

2. The bezel of claim 1, wherein the card reader is configured to read at least one of a magnetic stripe and a radio frequency-enabled card.

3. The bezel of claim 1, wherein the bill recycler access slot is configured to allow a user of the merchandising system to insert currency bills into and receive currency bills from the bill recycler.

4. The bezel of claim 1, wherein the graphic display displays a first pattern when a currency bill is inserted into the bill recycler and a second pattern when a currency bill is dispensed from the bill recycler.

5. The bezel of claim 1, wherein the visual indicators of the graphic display comprise horizontal bars arranged in a vertical column.

6. The bezel of claim 1, further comprising a control card, wherein at least one of the information display and the graphic display is controlled by the merchandising system via the control card.

7. The bezel of claim 6, wherein the information display comprises a touch sensitive input device and the control card communicates information from the touch sensitive input device to the merchandising system.

8. A merchandising system comprising:
a controller;
a bill recycler; and
a bezel, the bezel comprising:
an information display;
a graphic display comprising one or more visual indicators;
a card reader configured to read information from a cashless payment card; and
a bill recycler access slot providing access to the bill recycler,
wherein illumination of the graphic display is controlled in response to information received from the bill recycler.

9. The merchandising system of claim 8, wherein the card reader is configured to read at least one of a magnetic stripe and a radio frequency-enabled card.

10. The merchandising system of claim 8, wherein the bill recycler access slot is configured to allow a user of the merchandising system to insert currency bills into and receive currency bills from the bill recycler.

11. The merchandising system of claim 8, wherein the graphic display displays a first pattern when a currency bill is inserted into the bill recycler and a second pattern when a currency bill is dispensed from the bill recycler.

12. The merchandising system of claim 8, wherein the visual indicators of the graphic display comprise horizontal bars arranged in a vertical column.

13. The merchandising system of claim 8, wherein the bezel further comprises a control card, wherein at least one of the information display and the graphic display is controlled by the merchandising system via the control card.

14. The merchandising system of claim 13, wherein the information display comprises a touch sensitive input device and the control card communicates information from the touch sensitive input device to the merchandising system.

15. A method for operating a bezel in a merchandising system, the method comprising:
displaying a message in an information display;
receiving information related to a status of a bill recycler;
providing access for a currency bill through a bill recycler access slot operatively coupled to the bill recycler; and
illuminating a pattern of one or more visual indicators in a graphic display in response to the status of the bill recycler.

16. The method of claim 15, further comprising the step of determining whether a card reader has received payment information from a cashless payment card.

17. The method of claim 15, wherein the bill recycler access slot is configured to allow a user of the merchandising system to insert currency bills directly into and receive currency bills directly from the bill recycler.

18. The method of claim 15, wherein the graphic display displays a first pattern when a currency bill is inserted into the bill recycler and a second pattern when a currency bill is dispensed from the bill recycler.

19. The method of claim 15, wherein the visual indicators of the graphic display comprise horizontal bars arranged in a vertical column.

20. The method of claim 15, further comprising the step of controlling at least one of the information display and the graphic display via a control card in the bezel.
